(19) United States
(12) Patent Application Publication
(10) Pub. No.: US 2019/0061850 A1
(43) Pub. Date: Feb. 28, 2019

(54) MEMORY SADDLE WITH DOUBLE ELASTIC FOAM ASSEMBLY FOR VIBRATION ABSORPTION

(71) Applicant: DDK GROUP CO., LTD., BRANDAR SERI BEGAWAN (BN)

(72) Inventor: YING-CHIAO SUNG, TAICHUNG CITY (TW)

(21) Appl. No.: 15/725,467

(22) Filed: Oct. 5, 2017

(30) Foreign Application Priority Data
Aug. 28, 2017 (TW) 106212813

(51) Int. Cl. B62J 1/00; B32B 5/18; B32B 27/40; B32B 27/30; B32B 27/32; B32B 25/04; B32B 27/06; B62J 1/26

(52) U.S. Cl. CPC B62J 1/007; B32B 5/18; B32B 27/40; B32B 27/306; B32B 27/32; B32B 25/045; B32B 2307/51; B62J 1/26; B32B 2307/712; B32B 2605/00; B32B 2266/025; B32B 2266/0278; B32B 2266/0221; B32B 27/065

(57) ABSTRACT

A memory saddle includes a double elastic foam assembly, in which a saddle is structured to include a first foam material layer and a high-elasticity foam material layer formed on the first foam material layer. The first foam material layer is formed with a first hollowed zone at a location thereof corresponding to an ischiatic pressure bearing zone of the saddle. A second foam material layer is received in and coupled to the first hollowed zone. The high-elasticity foam material layer is formed with a second hollowed zone at a location corresponding to the ischium and a memory foam layer is received in and coupled to the second hollowed zone such that the memory foam layer is in alignment, in a vertical direction, with the second foam material layer received in the first hollowed zone.

### BACKGROUND OF THE INVENTION

### 1. Field of the Invention

The present invention relates to a vibration-absorbing structure of a saddle, and in particular to a double elastic foam assembly for a saddle.

### 2. The Related Arts

In the conventional designs of saddles of bicycles or electric vehicles, to protect a cyclist from excessive shocks and vibration in riding the bicycle or electrical vehicle, helical springs are often provided on the underside of the saddle to function as a primary measure for vibration absorption. Assembly of such a vibration-absorbing structure is generally difficult and requires a large amount of human labor. In practical operations, the helical springs may be just good in absorbing vibrating forces of relatively large magnitudes.

As to the main body of the saddle, different materials, such as foaming materials, rubber materials, and fabric, have been used to make the saddle in order to provide vibration absorption to the cyclist while riding. This, although simplifying assembly of components, provides no satisfactory performance of vibration absorption in actual uses.

### SUMMARY OF THE INVENTION

In view of the above, the primary objective of the present invention is to provide a memory saddle that includes a double elastic foam assembly in order to provide a bicycle or an electric vehicle with a saddle featuring better vibration-absorbing performance in actual uses.

A technical solution adopted in the present invention is that a saddle is structured to comprise a first foam material layer and a high-elasticity foam material layer formed on the first foam material layer. The first foam material layer is formed with a first hollowed zone at a location thereof corresponding to an ischiatic pressure bearing zone of the saddle. A second foam material layer is received in and coupled to the first hollowed zone. The high-elasticity foam material layer is formed with a second hollowed zone at a location corresponding to the ischium and a memory foam layer is received in and coupled to the second hollowed zone such that the memory foam layer is in alignment, in a vertical direction, with the second foam material layer received in the first hollowed zone.

In the above saddle, the high-elasticity foam material layer of the saddle has a surface that is provided with and covered by a water-resistant surface layer.

In the above saddle, the high-elasticity foam material layer is formed of a material that is selected as a foaming material of one of polyurethane and ethylene vinyl acetate copolymer.

In the above saddle, the first foam material layer is formed of a polypropylene material.

In the above saddle, the second foam material layer is formed of a thermoplastic rubber material.

Concerning efficacy, when a cyclist sits on the saddle, the ischiatic pressure bearing zone of the saddle receives and bears a vibration force that the ischium of the cyclist applied thereto in a vertical direction and the memory foam layer and the second foam material layer of the double elastic foam assembly of the present invention collaboratively absorb the vibration force to thereby effectively improve the cyclist's comfortableness of riding.

### BRIEF DESCRIPTION OF THE DRAWINGS

The present invention will be apparent to those skilled in the art by reading the following description of preferred embodiments of the present invention, with reference to the attached drawings, in which:

FIG. 1 is a side elevational view, in a schematic form, illustrating a saddle combined with a double elastic foam assembly according to the present invention;

FIG. 2 is a perspective view, in a schematic form, illustrating the saddle combined with the double elastic foam assembly according to the present invention;

FIG. 3 is a cross-sectional view taken along line 3-3 of FIG. 2;

FIG. 4 is a cross-sectional view similar to FIG. 3, illustrating a condition that a cyclist is about to sit on the saddle; and

FIG. 5 is a cross-sectional view, illustrating a condition that the cyclist sits on the saddle with the ischiums of the cyclist applying a force to the saddle.

### DETAILED DESCRIPTION OF THE PREFERRED EMBODIMENTS

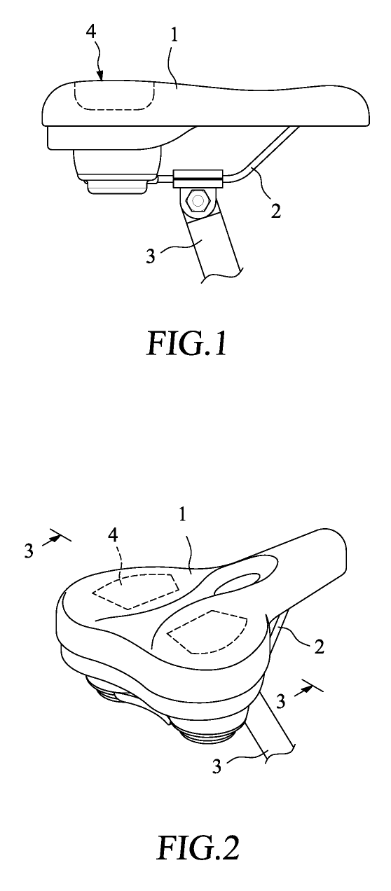

Referring to FIGS. 1 and 2, FIG. 1 is a side elevational view, in a schematic form, illustrating a saddle combined with a double elastic foam assembly according to the present invention, and FIG. 2 is a perspective view, in a schematic form, illustrating the saddle combined with the double elastic foam assembly according to the present invention. As shown in the drawings, a saddle 1 is coupled, at a bottom thereof, to a support frame 2, and the support frame 2 is further coupled to an upright post 3. The saddle 1 can be a saddle of a bicycle, an electric bicycle or an electric vehicle.

When a cyclist sits on the saddle 1, two zones of the saddle 1 that correspond to portions of the cyclist's body associated with the ischiums of the cyclist are defined as ischiatic pressure bearing zones P. In this invention, a pair of elastic foam assemblies 4 are arranged in the ischiatic pressure bearing zones P respectively of the saddle 1, as shown in FIG. 2. The arrangement of the elastic foam assemblies 4 provides better vibration absorption of the ischiatic pressures supported by the cyclist while riding.

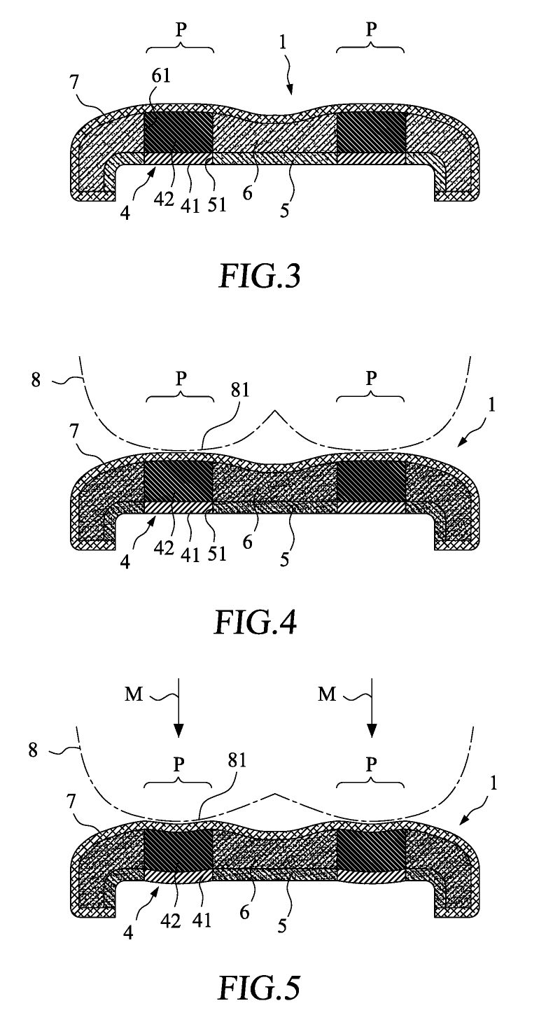

FIG. 3 is a cross-sectional view taken along line 3-3 of FIG. 2. As shown in the drawing, the saddle 1 comprises a first foam material layer 5 and a high-elasticity foam material layer 6 formed on the first foam material layer 5. The high-elasticity foam material layer 6 may be provided, on a surface thereof, with a water-resistant surface layer 7 covering the surface.

The first foam material layer 5 is formed with a first hollowed zone 51 at a location thereof corresponding to each of the ischiatic pressure bearing zones P of the saddle 1, and the first hollowed zone 51 receives and is coupled to a second foam material layer 41 filled therein. The second foam material layer 41 is made of a material that has a material density that is smaller that a material density of a material that makes the first foam material layer 5 so that the second foam material layer 41 exhibits a better capability of vibration absorption.

In manufacture, the first foam material layer 5 can be made of a material that is selected as a polypropylene (PP) material that is subjected to a foam material injection molding operation to form a structure that comprises the first hollowed zones 51. And, then, a second foam material injection molding operation is applied to the first hollowed zones 51 to fill the second foam material layers 41 therein. The second foam material layer 41 can be made of a material that is selected as thermoplastic rubber (TPR) material.

The high-elasticity foam material layers 6 are formed with second hollowed zones 61 at locations respectively corresponding to the ischiatic pressure bearing zones P and the second hollowed zones 61 each receives a memory foam layer 42 arranged therein and coupled thereto, such that the memory foam layers 42 are respectively in alignment, in a vertical direction, to the second foam material layers 41 received in the first hollowed zones 51 of the first foam material layer 5. The memory foam layers 42 and the second foam material layers 41 collectively form the double elastic foam assembly 4 of this invention.

In manufacture, the high-elasticity foam material layer 6 can be made of a material that is selected as a foaming material of polyurethanes (PU) or ethylene vinyl acetate (EVA), which is subjected to a foam material injection molding operation to form a structure comprising the second hollowed zones 61. And, then, a second foam material injection molding operation is applied to the second hollowed zones 61 to fill the memory foam layers 42 therein. The memory foam layer 42 is primarily made of a polyurethane high-molecule material, exhibiting property of both viscosity and elasticity, so that when the memory foam layer 42 is deformed with an external force applied thereto, the memory foam layer 42 may slowly restore the original shape, after the force is removed, so as to absorb the energy of vibration and impact.

FIG. 4 is a cross-sectional view similar to FIG. 3, illustrating a condition that a cyclist 8 is about to sit on the saddle 1, wherein the ischiums 81 of the cyclist 8 correspond to the ischiatic pressure bearing zones P of the saddle 1 and is generally in alignment with the memory foam layers 42 and the second foam material layers 41.

Referring also to FIG. 5, when the ischiatic pressure bearing zones P of the saddle 1 receive and bear vibration forces M that the ischiums 81 of the cyclist 8 apply thereto in a vertical direction, the memory foam layers 42 and the second foam material layers 41 collaboratively absorb the vibration forces to thereby provide better vibration absorption of the ischiatic pressures supported by the cyclist 8 while riding.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A double elastic foam assembly for a saddle including a first foam material layer and a high-elasticity foam material layer formed on the first foam material layer, the saddle being adapted to receive a cyclist to sit thereon so that two portions of the saddle that correspond to portions of the cyclist associated with the ischiums of the cyclist are defined as ischiatic pressure bearing zones, comprising:
a first foam material layer formed with a pair of first hollowed zones at locations corresponding to the ischiatic pressure bearing zones of the saddle, each of the first hollowed zones receiving therein a second foam material layer; and
a high-elasticity foam material layer formed with a pair of second hollowed zones at locations corresponding to the ischiums of the cyclist, each of the second hollowed zones receiving therein a memory foam layer that is in alignment, in a vertical direction, with the second foam material layer of the first hollowed zone;
wherein the ischiatic pressure bearing zones of the saddle receive and bear vibration forces applied by the ischiums of the cyclist thereto in the vertical direction, and the memory foam layers and the second foam material layers collaboratively absorb the vibration forces.

2. The double elastic foam assembly as claimed in claim 1, wherein the high-elasticity foam material layer of the saddle has a surface that is provided with and covered by a water-resistant surface layer.

3. The double elastic foam assembly as claimed in claim 1, wherein the high-elasticity foam material layer is formed of a material that is selected as a foaming material of one of polyurethane and ethylene vinyl acetate copolymer.

4. The double elastic foam assembly as claimed in claim 1, wherein the first foam material layer is formed of a polypropylene material.

5. The double elastic foam assembly as claimed in claim 1, wherein the second foam material layer is formed of a thermoplastic rubber material.
